(19) United States
(12) Patent Application Publication
(10) Pub. No.: US 2015/0113553 A1
(43) Pub. Date: Apr. 23, 2015

(54) Data Transfer in a Media Delivery System

(71) Applicant: Yang Pan, Singapore (SG)

(72) Inventor: Yang Pan, Singapore (SG)

(21) Appl. No.: 14/058,242

(22) Filed: Oct. 20, 2013

(51) Int. Cl. H04N 21/422; H04N 21/414; G08C 17/02; H04N 21/4363

(52) U.S. Cl. CPC H04N 21/42219; H04N 21/42224; H04N 21/42221; H04N 21/42208; H04N 21/43637; H04N 21/41407; G08C 17/02; G08C 2201/20; G08C 2201/30; G08C 2201/40; G08C 2201/93
USPC 725/32; 725/81

(57) ABSTRACT

In one embodiment, a media delivery system including a television, a smart phone and a smart watch comprises an ad hoc communication network. The smart phone is employed as remote control. In one implementation, the smart phone controls the television directly. In another implementation, the smart phone controls the television through the smart watch. A media item stored in the smart watch can be rendered by the television using the smart phone as the remote control. An advertising message can be transferred from the television to the smart watch using the smart phone as the remote control. In other embodiments, the smart watch or a tablet computer can be used as the remote control.

### CROSS-REFERENCE TO RELATED APPLICATIONS

Not applicable.

### BACKGROUND

1. Field of Invention

This invention relates generally to data transfer in a media delivery system. More specifically, the invention relates to data transfer in a media delivery system including a television system and personal communication devices.

2. Description of Prior Art

Personal mobile devices have gained significant popularity in recent years. Users are using the mobile device such as, for example, iPhone, iPod and iPad from Apple Inc, Cupertino, Calif., to enjoy media assets and to access the Internet services. Methods for delivering video programs to users by employing personal mobile devices have been developed.

Because of significantly larger display size and comfortable environment in a living room, many of video programs have still been delivered to users through a television (TV) system. Media items are stored in different personal devices. Therefore, it is desirable to have an easy method for transferring the media items among the personal devices and the television system. It is further desirable to use one of the personal devices to remotely control the media item transfer.

### SUMMARY OF THE INVENTION

It is an object of the present invention to providing a system and method for transferring media items between a personal communication device and a television system.

It is another object of the present invention to providing a system and method for transferring media items between the personal communication device and the television system under remote control of another personal communication device.

In a first embodiment, the media delivery system includes a smart wristwatch (or smart watch) connected to a television system through a first ad hoc communication link. A smart phone is connected to the smart watch as a remote control device through second ad hoc communication link. The smart phone controls remotely data transfer between the television system and the smart watch via the smart watch through the first and the second communication links. In another implementation, the smart phone is further connected to the television system through a third ad hoc communication link. The smart phone controls remotely data transfer between the television system and the smart watch through the television system. In one aspect, a media item stored in a storage unit of the smart watch is transferred to the television system and is rendered by employing the television system. In another aspect, an advertising message is transferred from the television system to the smart watch.

In an exemplary case, the smart phone includes a touch-sensitive display. Movements of a user's finger are synchronized to movements of an optical symbol on a display of the television system. A user can select a displayed item from a displayed menu for controlling of operations of the system.

In a second embodiment, the smart phone is connected to television system and the smart watch is used as the remote control device.

In a third embodiment, the smart watch is connected to the television system and a tablet computer is used as the remote control device.

In a forth embodiment, the tablet computer is connected to the television system and the smart watch is used as the remote control device.

In a fifth embodiment, the smart phone is connected to the television system and the tablet computer is used as the remote control device.

In a sixth embodiment, the tablet computer is connected to the system and the smart phone is used as the remote control device.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram of an exemplary media delivery system with the smart phone as the remote control connected to both smart watch and the television system in accordance with a first embodiment;

FIG. 2 is a schematic diagram of an exemplary media delivery system with the smart phone as the remote control connected to only the smart watch in accordance with the first embodiment;

FIG. 3 is a schematic functional block diagram for the media delivery system in accordance with the first embodiment;

FIG. 4 is a flowchart illustrating operations of the media delivery system for rendering a media item in accordance with one implementation of the first embodiment;

FIG. 5 is a flowchart illustrating operations of the media delivery system for rendering a media item in accordance with another implementation of the first embodiment;

FIG. 6 is a flowchart illustrating operations of the media delivery system for delivering an advertising message in accordance with one implementation of the first embodiment;

FIG. 7 is a flowchart illustrating operations of the media delivery system for delivering an advertising message in accordance with another implementation of the first embodiment;

FIG. 8 is a flowchart illustrating generic data transfer in the media delivery system in accordance with one aspect of the first embodiment;

FIG. 9 is a flowchart illustrating generic data transfer in the media delivery system in accordance with another aspect of the first embodiment;

FIG. 10 is a schematic diagram of an exemplary media delivery system with a smart watch as the remote control and a smart phone connected to a television system in accordance with a second embodiment;

FIG. 11 is a schematic diagram of an exemplary media delivery system with a tablet computer as the remote control and a smart watch connected to a television system in accordance with a third embodiment;

FIG. 12 is a schematic diagram of an exemplary media delivery system with a smart watch as the remote control and a tablet computer connected to a television system in accordance with a forth embodiment;

FIG. 13 is a schematic diagram of an exemplary media delivery system with a tablet computer as the remote control and a smart phone connected to a television system in accordance with a fifth embodiment;

FIG. 14 is a schematic diagram of an exemplary media delivery system with a smart phone as the remote control and a tablet computer connected to a television system in accordance with a sixth embodiment.

### DETAILED DESCRIPTION

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefits of this disclosure.

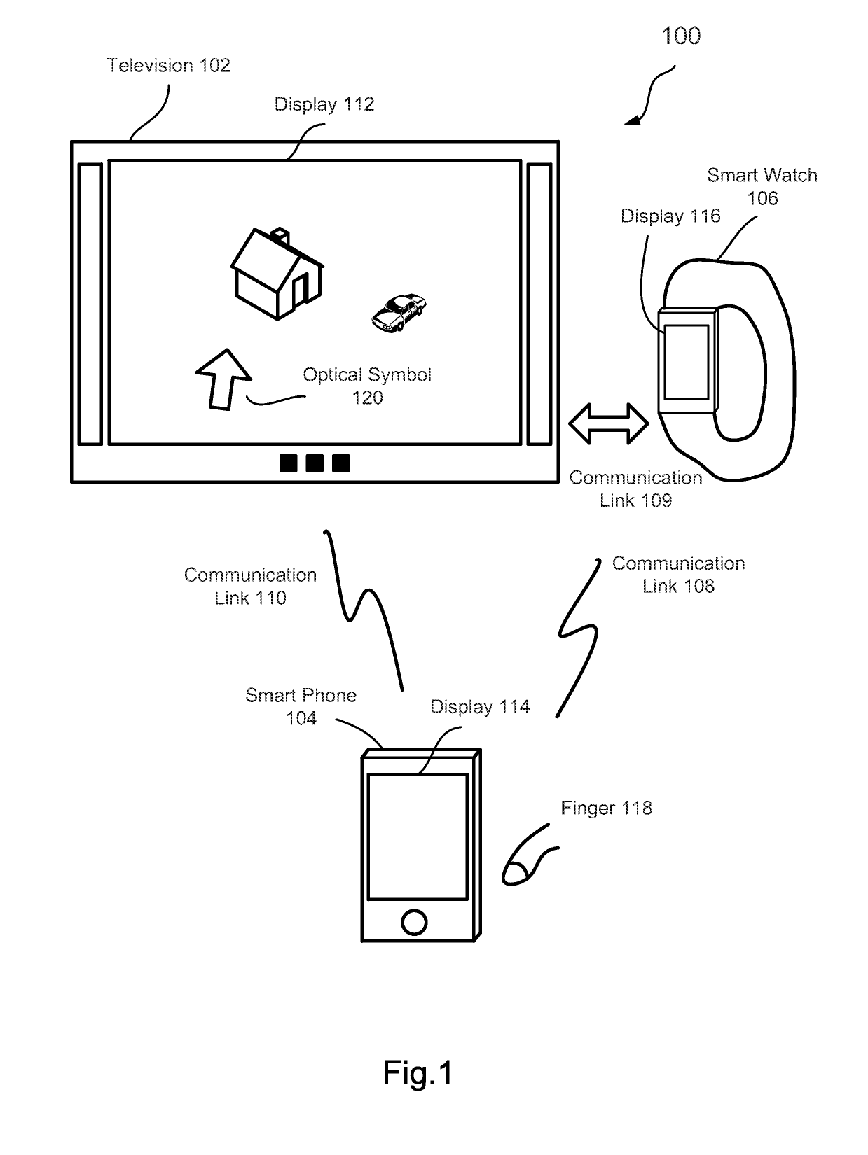

FIG. 1 is a schematic diagram illustrating an exemplary media delivery system 100 in accordance with a first embodiment. System 100 includes television system 102, smart phone 104 and smart watch 106. Smart watch 106 is a wrist wearable device. Smart phone 104 and smart watch 106 are connected through an ad hoc wireless communication link 108. Ad hoc communication link 108 may be conformed to various IEEE and ISO standards and their extensions such as, for example, IEEE 802.15.1 (Bluetooth), IEEE 802.15.4 (ZigBee), IEEE 802.11x (WiFi) and ISO 18092, ISO 21481 and Transfer Jet Protocol for Near Field Communication (NFC). Smart watch 106 is connected to television system 102 through communication link 109. In one implementation, communication link 109 is a wired connection including a docking system. The docking system for connecting two electronic devices are well known in the art including but not limited to an IEEE 1394 type of connection and a Universal Serial Bus (USB) type of connection. In another implementation, communication link 109 is an ad hoc wireless communication link including but not limited to a Bluetooth type of connection, a ZigBee type of connection, a WiFi type of connection and a NFC type of connection. In one implementation, a reader is located in television system 102 and a tag is located in smart watch 106. In another implementation, a reader and a tag are included in television system 102 and another reader and another tag are included in smart watch 106.

In one aspect of the first embodiment, smart phone 104 is connected to television system 102 through another ad hoc communication link 110. A control signal generated by smart phone 104 is transmitted to television system 102 through ad hoc communication link 110. Smart phone 104 is used as a remote control device for system 100. Smart phone 104 as the remote control device controls at least data transfer between television system 102 and smart watch 106. Smart phone 104 as the remote control device may further control data transfer among television system 102, smart watch 106 and smart phone 104. Smart phone 104 as the remote control device may still provide other control functions for television system 102 similar to a typical dedicated remote control device for a television. Ad hoc communication link 110 may be conformed to the same protocol as communication link 108. Ad hoc communication link 110 may be conformed to a different communication protocol including but not limited to a Bluetooth type of connection, a ZigBee type of connection, a WiFi type of connection and a NFC type of connection.

Television system 102 includes display 112 and smart phone 104 includes a display 114. Smart watch 106 includes display 116. In an exemplary case, display 114 is a touch-sensitive type of display. A user's finger 118 touches display 114 and a control signal is generated by a processor of smart phone 104. The control signal is transmitted to television system 102 through communication link 110. In response to received control signal by a processor in television system 102, displayed optical symbol 120 moves accordingly on display 112. Movements of finger 118 on display 114 and movements of optical symbol 120 are synchronized. Optical symbol 120 may be pointed to a user selectable item on a displayed menu on display 112. The user may actuate display 114 using finger 118 to select pointed item on display 112.

Display 114 is a Liquid Crystal Display (LCD) in an exemplary case. Display 114 using LCD includes a means of back illumination. Smart phone 104 as the remote control device may have the back illumination at a switched on status. Smart phone 104 as the remote control device may have the back illumination at a switched off status and utilizes only touch sensitive functions.

Smart watch 106 includes a plurality media items stored in a data storage unit. Metadata of the media items may be transmitted to television system 102 through communication link 109. The media items are organized exemplarily in a hierarchical manner. In an exemplary case, a hierarchical user interface is displayed on display 112 for accessing media items stored in smart watch 106. The hierarchical user interface may be a part of user interface of television system 102. The user selects a media item through smart phone 104. Selected media item is retrieved from the storage unit of smart watch 106 and is transmitted to television system 102 through communication link 109. The processor of television system 102 receives the media item and renders received media item through television system 102. The media item includes a video program.

In another aspect, a video program may be rendered by television system 102. The video program includes at least one advertising message. The user operates smart phone 104 to generate a control signal. The control signal is transmitted to television system 102 through communication link 110. In response to received control signal, the advertising message is transmitted from television system 102 to smart watch 106. Received advertising message may be stored in the data storage unit of smart watch 106. Received advertising message may further be transmitted to smart phone 104 and be rendered by smart phone 104 in a later time.

In another aspect, a video program being rendered can be recorded and be stored in the data storage unit of smart watch 106. The user may also select a scheduled video program from a program list through the user interface of television system 102 using smart phone 104. Scheduled video program may be recorded and be stored in smart watch 106 according to the schedule. Smart phone 104 may or may not be presented when scheduled video program is recorded. Recorded video program may be transmitted to smart phone 104 in a later time and be rendered by smart phone 104.

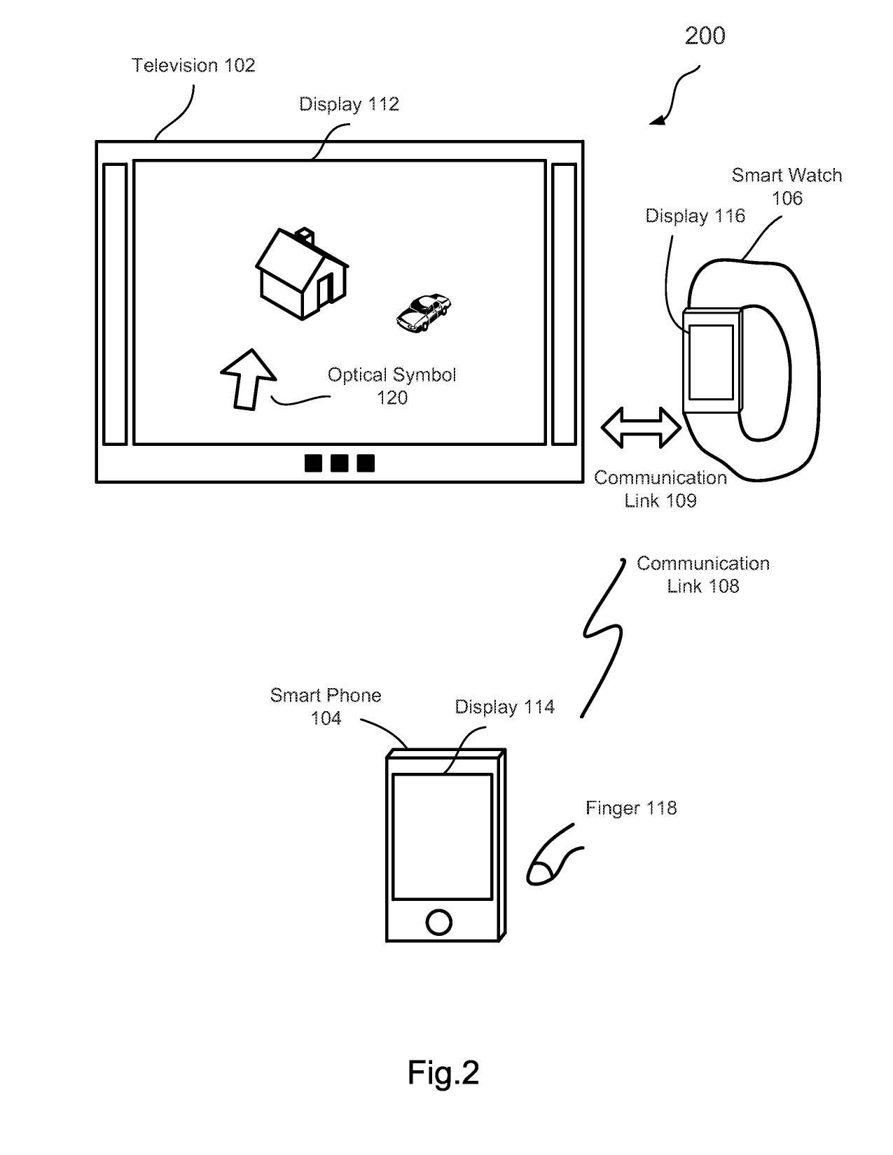

According to another implementation of the first embodiment as shown in FIG. 2, the control signal generated by finger 118 is transmitted to television system 102 through smart watch 106. Communication links 108 and 109 are employed for transmitting the control signal.

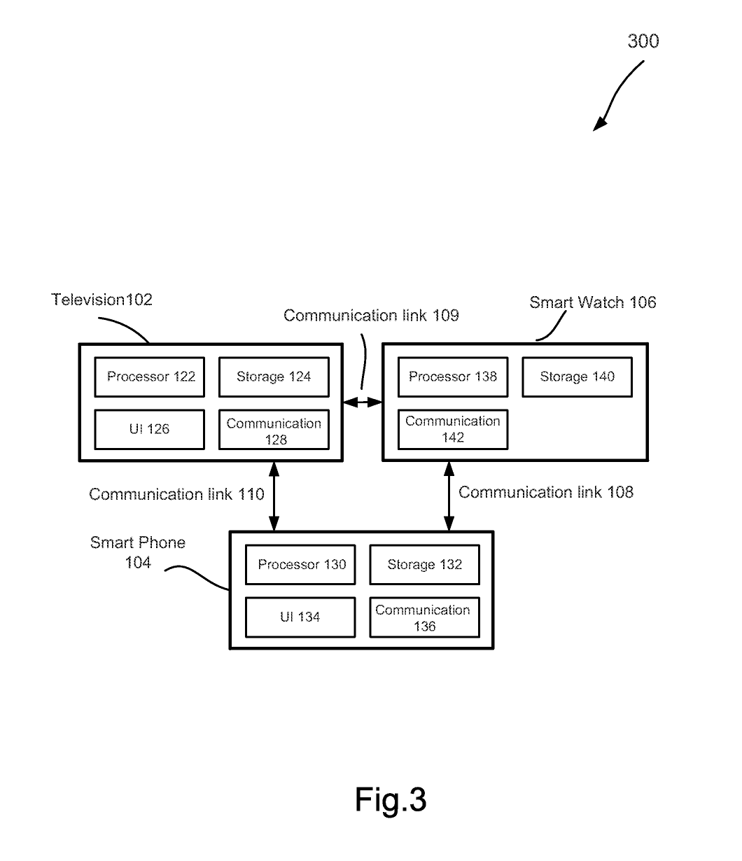

A functional block diagram of exemplary media delivery system 300 is shown in FIG. 3. Subsystems of television system 102 include but are not limited to processor 122 pertaining to controlling operations of television system 102, data storage unit 124 pertaining to storing data, UI 126 including a user interface for selecting a media item stored in smart watch 106 and communication unit 128 pertaining to sending and receiving data from communication link 109 and communication link 110. Subsystems of smart phone 104 includes but are not limited to processor 130 pertaining to controlling operations of smart phone 104, data storage unit 132 pertaining to storing data, UI 134 and communication unit 136 pertaining to sending and receiving data from communication link 108 and communication link 110. Subsystems of smart watch 106 includes but are not limited to processor 138 pertaining to controlling operations of smart watch 106, data storage unit 140 pertaining to storing data including the media items and communication unit 142 pertaining to sending and receiving data from communication link 108 and communication link 109.

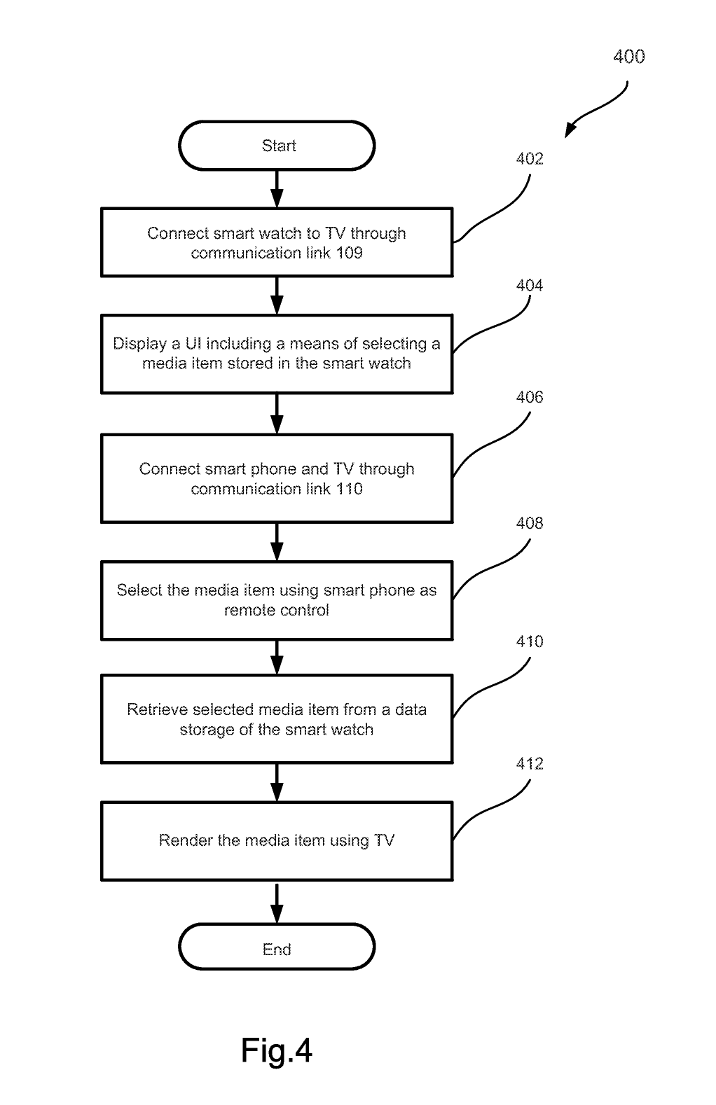

FIG. 4 is a flowchart illustrating operations of the media delivery system 100 for rendering a media item in accordance with one implementation of the first embodiment. Process 400 starts with step 402 that smart watch 106 is connected to television system 102 through communication link 109. Communication link 109 may be a wired connection through a docking system. Communication link 109 may also be an ad hoc wireless communication link such as, for example, a Bluetooth type of connection. Metadata of the media items stored in smart watch 106 are transmitted from smart watch 106 to television system 102 through communication link 109. UI 126 is displayed by processor 122 on display 112 in step 404. In an exemplary case, UI 126 includes multiple hierarchical levels pertaining to guiding the user to select a media item from the media items stored in smart watch 106. Smart phone 104 and television system 102 are connected through communication link 110 in step 406. Smart phone 104 is used as a remote control device. A media item is selected in step 408 by the user employing smart phone 104. In response to the user's selection, selected media item is retrieved from data storage unit 140 of smart watch 106 in step 410. Retrieved media item is transmitted from smart watch 106 to television system 102 through communication link 109. Received media item is rendered by processor 122 using television system 102 in step 412.

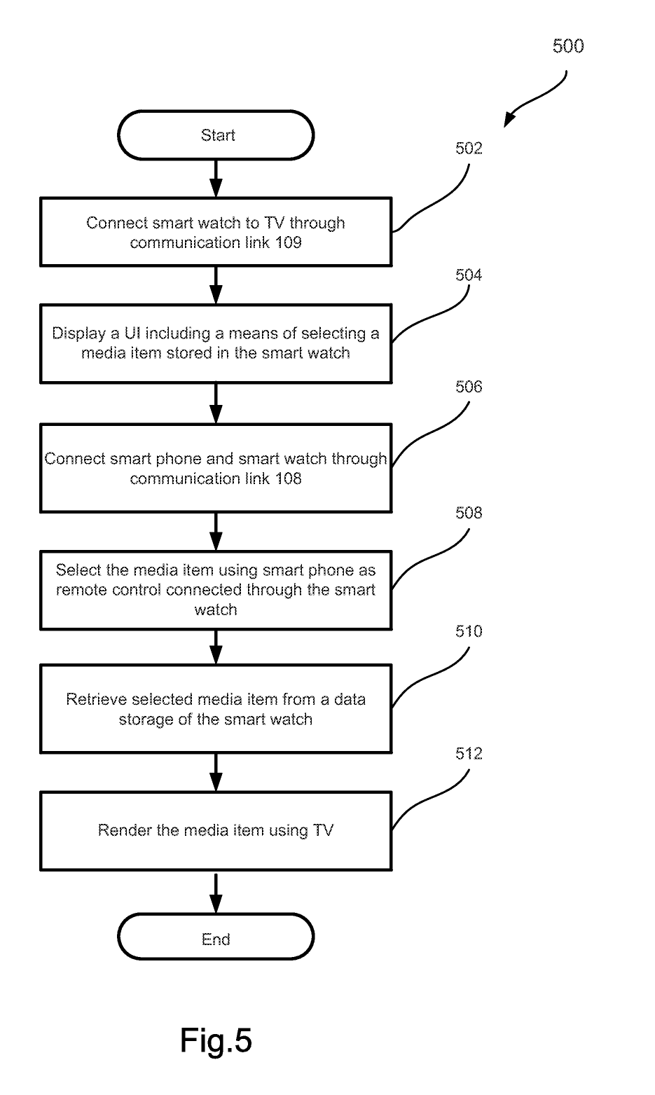

FIG. 5 is a flowchart illustrating operations of the media delivery system 200 for rendering a media item in accordance with another implementation of the first embodiment. Process 500 starts with step 502 that smart watch 106 is connected to television system 102 through communication link 109. Communication link 109 may be a wired connection through a docking system. Communication link 109 may also be an ad hoc wireless communication link such as, for example, a Bluetooth type of connection. Metadata of media items stored in smart watch 106 are transmitted from smart watch 106 to television system 102 through communication link 109. UI 126 is displayed by processor 122 on display 112 in step 504. In an exemplary case, UI 126 includes multiple hierarchical levels pertaining to guiding the user to select a media item from the media items stored in smart watch 106. Smart phone 104 is connected to smart watch 106 through communication link 108 in step 506. Smart phone 104 is used as a remote control device for television system 102 via smart watch 106. A media item is selected in step 508 by the user employing smart phone 104 as the remote control. In response to the user's selection, selected media item is retrieved from data storage unit 140 of smart watch 106 in step 510. Retrieved media item is transmitted from smart watch 106 to television system 102 through communication link 109. Received media item is rendered by processor 122 using television system 102 in step 512.

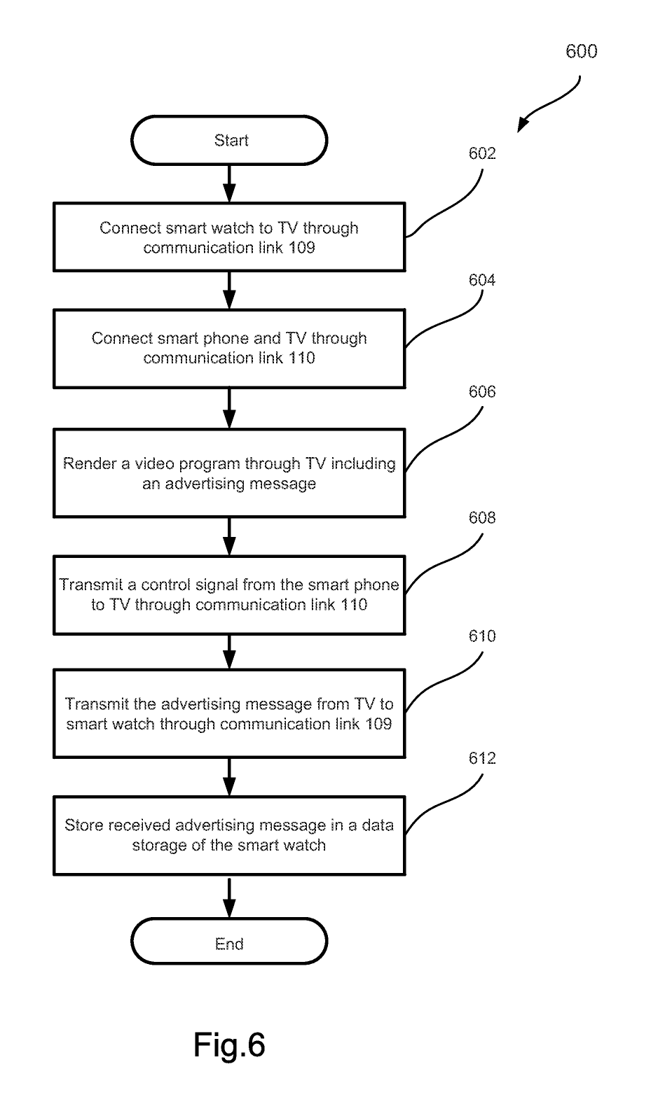

FIG. 6 is a flowchart illustrating operations of the media delivery system 100 for delivering an advertising message in accordance with one implementation of the first embodiment. Process 600 starts with step 602 that smart watch 106 is connected to television system 102 through communication link 109. Communication link 109 may be a wired connection through a docking system. Communication link 109 may also be an ad hoc wireless communication link such as, for example, a Bluetooth type of connection. Smart phone 104 and television system 102 are connected through communication link 110 in step 604. Smart phone 104 is used as a remote control device. A video program including at least one advertising message is rendered by television system 102 in step 606. The user touches display 114 of smart phone 104 to generate a control signal. The control signal is transmitted from smart phone 104 to television system 102 in step 608 through communication link 110. In response to received control signal, the advertising message is transmitted from television system 102 to smart watch 106 in step 610. Received advertising message is stored in data storage unit 140 of smart watch 106 in step 612.

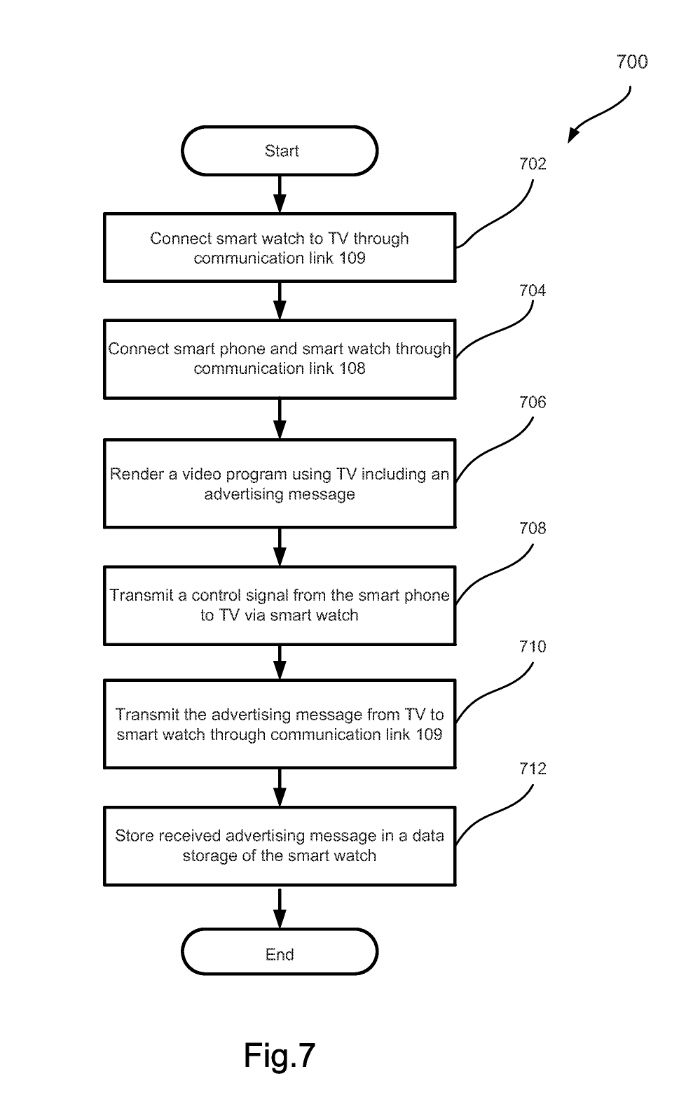

FIG. 7 is a flowchart illustrating operations of the media delivery system 200 for delivering an advertising message in accordance with another implementation of the first embodiment. Process 700 starts with step 702 that smart watch 106 is connected to television system 102 through communication link 109. Communication link 109 may be a wired connection through a docking system. Communication link 109 may also be an ad hoc wireless communication link such as, for example, a Bluetooth type of connection. Smart phone 104 and smart watch 106 are connected through communication link 108 in step 704. Smart phone 104 is used as a remote control device via smart watch 106. A video program including at least one advertising message is rendered by television system 102 in step 706. A control signal is generated by smart phone 104 after finger 118 touches display 114. The control signal is transmitted from smart phone 104 to television system 102 via smart watch 106 in step 708 through communication links 108 and 109. In response to received control signal, the advertising message is transmitted from television system 102 to smart watch 106 in step 710. Received advertising message is stored in data storage unit 140 of smart watch 106 in step 712.

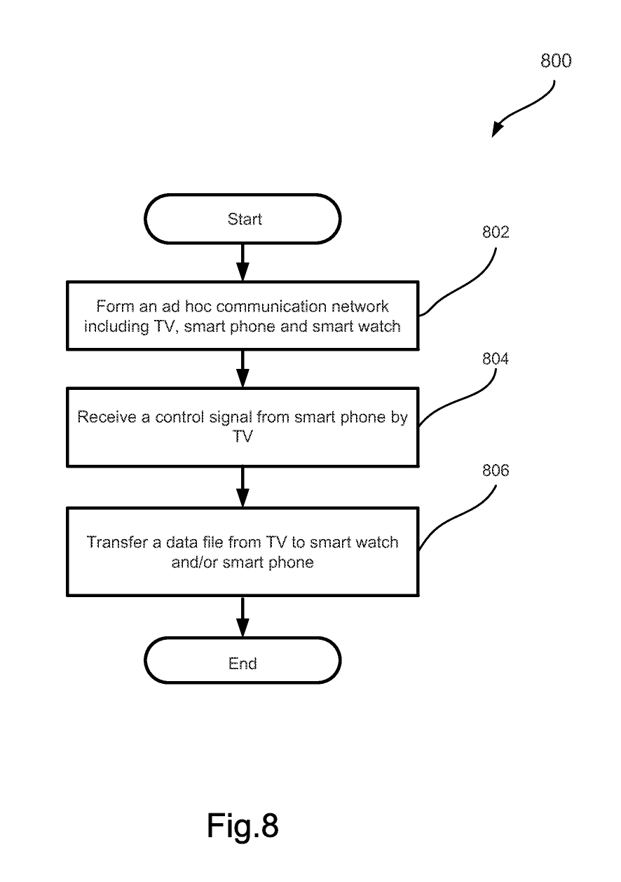

FIG. 8 is a flowchart illustrating generic data transfer in the media delivery system in accordance with one aspect of the first embodiment. Process 800 starts with step 802 that an ad hoc communication network is formed including at least television system 102, smart phone 104 and smart watch 106. Smart phone 104 is used as a remote control device. A control signal generated by smart phone 104 is received by television system 102 in step 804. In response to received control signal, a data file is transmitted from television system 102 to smart watch 106 and/or to smart phone 104 in step 806. In one implementation, the data file includes advertising message. In another implementation, the data file includes at least a part of video program being rendered by television system 102. In yet another implementation, the data file includes a pre-selected video program by the user through a program list. The video program is recorded and is transmitted to smart watch 106 and/or smart phone 104. In another aspect of step 806, selected media items can be transmitted from smart watch 106 to television system 102 remotely controlled by smart phone 104.

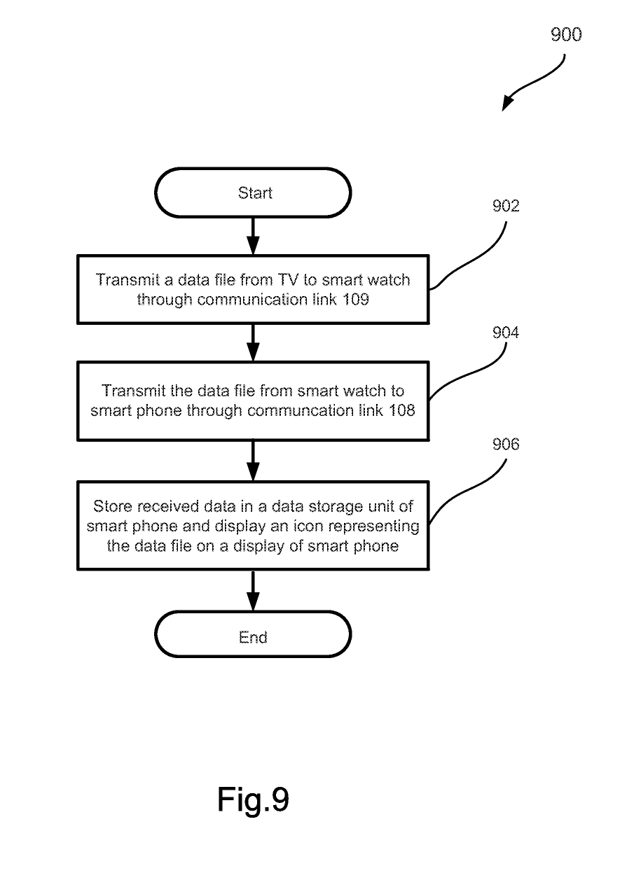

FIG. 9 is a flowchart illustrating generic data transfer in the media delivery system in accordance with another aspect of the first embodiment. Process 900 starts with step 902 that a data file is transmitted from television system 102 to smart watch 106 through communication link 109. In step 904, the data file is further transmitted from smart watch 106 to smart phone 104 through communication link 108. Received data file is stored in data storage unit 132 of smart phone 104 in step 906. An icon representing the data file is displayed on display 114 of smart phone 104. The user may access the data file by selecting displayed icon by touching the icon using finger 118.

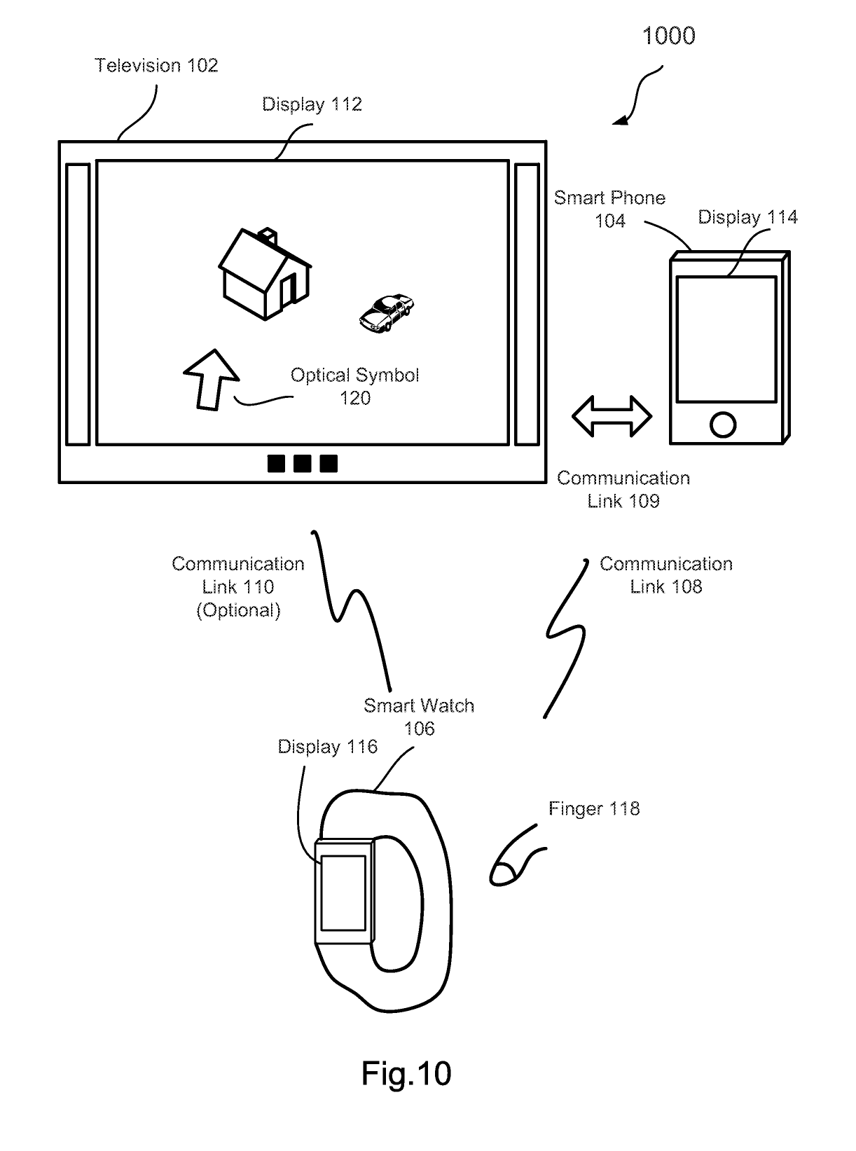

FIG. 10 is a schematic diagram of an exemplary media delivery system 1000 in accordance with a second embodiment. System 1000 includes television system 102, smart phone 104 and smart watch 106. Smart phone 104 is connected to television system 102 through communication link 109. Smart watch 106 is connected to smart phone 104 through communication link 108. Smart watch 106 can be connected optionally to television system 102 through communication link 110. Finger 118 touches display 116 of smart watch 106 and a control signal is generated. In one aspect, generated control signal is transmitted from smart watch 106 to television system 102 through communication link 110. In another implementation, generated control signal is transmitted from smart watch 106 to television system 102 via smart phone 104 through communication links 108 and 109. Movements of finger 118 on display 116 are synchronized to movements of optical symbol 120 on display 112. In one aspect, system 1000 may be used to render a media item stored in smart phone 104 through remote control 106. In another aspect, system 1000 may be used to transfer an advertising message from television system 102 to smart phone 104. In yet another aspect, system 1000 may be used to transfer at least a part of video program being rendered by television system 102 to smart phone 104 and/or to smart watch 106. In still another aspect, system 1000 may be used to transfer a recorded video program from television system 102 to smart phone 104 and/or to smart watch 106. The video program may be pre-selected by the user through a program list and be recorded according to a schedule.

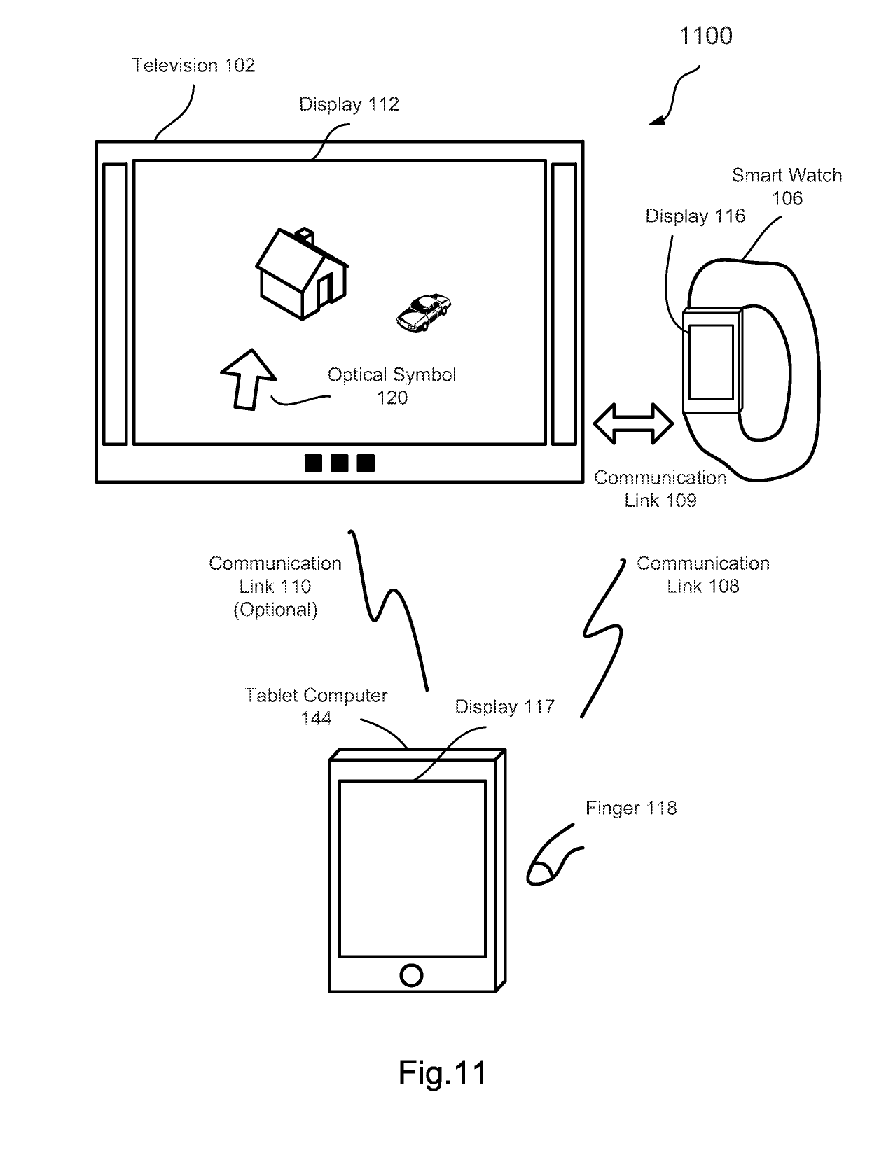

FIG. 11 is a schematic diagram of an exemplary media delivery system 1100 in accordance with a third embodiment. System 1100 includes television system 102, smart watch 106 and tablet computer 144. Smart watch 106 is connected to television system 102 through communication link 109. Tablet computer 144 is connected to smart watch 106 through communication link 108. Tablet computer 144 can be connected optionally to television system 102 through communication link 110. Finger 118 touches display 117 of tablet computer 144 and a control signal is generated. In one implementation, generated control signal is transmitted from tablet computer 144 to television system 102 through communication link 110. In another implementation, generated control signal is transmitted from tablet computer 144 to television system 102 via smart watch 106 through communication links 108 and 109. Movements of finger 118 on display 117 are synchronized to movements of optical symbol 120 on display 112. In one aspect, system 1100 may be used to render a media item stored in smart watch 106 through remote control 144. In another aspect, system 1100 may be used to transfer an advertising message from television system 102 to smart watch 106. In yet another aspect, system 1100 may be used to transfer at least a part of video program being rendered by television system 102 to smart watch 106 and/or to tablet computer 144. In still another aspect, system 1100 may be used to transfer a recorded video program from television system 102 to smart watch 106 and/or to tablet computer 144. The video program may be pre-selected by the user through a program list and be recorded according a schedule.

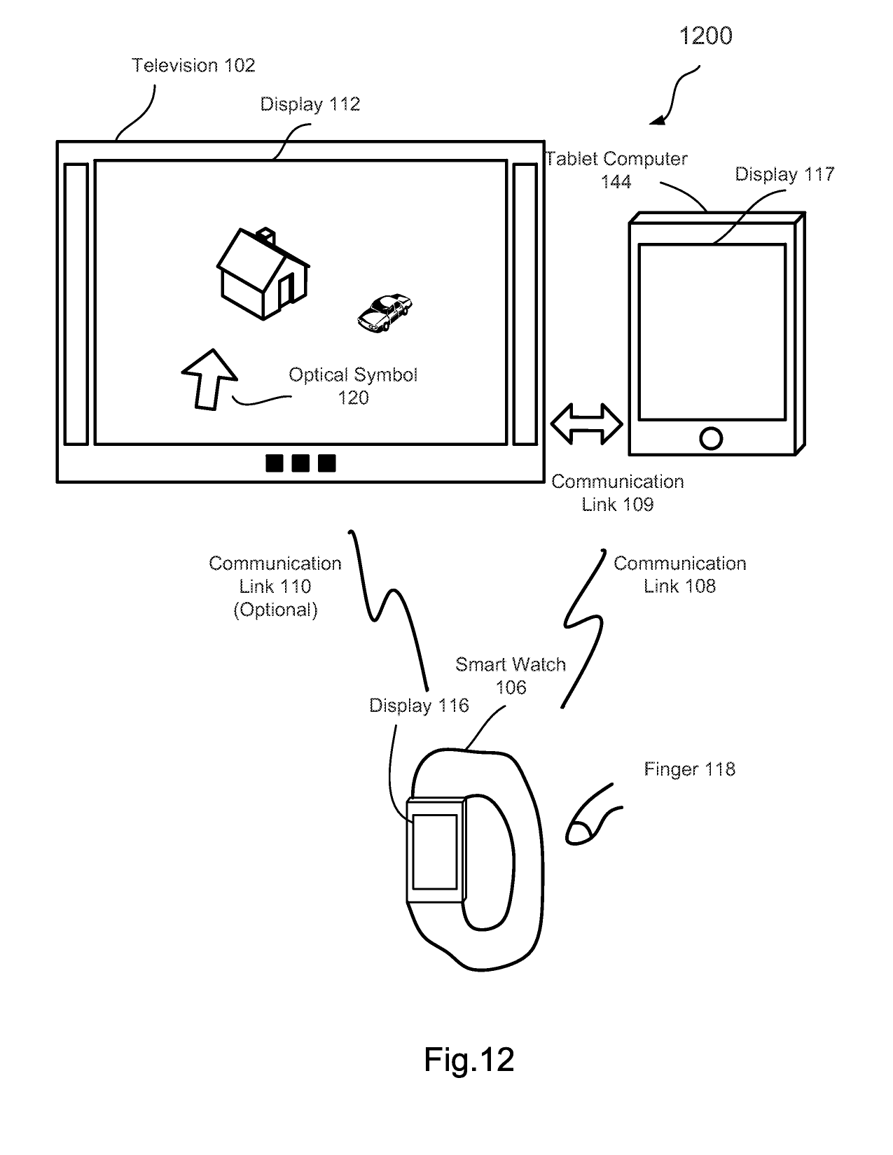

FIG. 12 is a schematic diagram of an exemplary media delivery system 1200 in accordance with a forth embodiment. System 1200 includes television system 102, smart watch 106 and tablet computer 144. Tablet computer 144 is connected to television system 102 through communication link 109. Smart watch 106 is connected to tablet computer 144 through communication link 108. Smart watch 106 can be connected optionally to television system 102 through communication link 110. Finger 118 touches display 116 of smart watch 106 and a control signal is generated. In one implementation, generated control signal is transmitted from smart watch 106 to television system 102 through communication link 110. In another implementation, generated control signal is transmitted from smart watch 106 to television system 102 via tablet computer 144 through communication links 108 and 109. Movements of finger 118 on display 116 are synchronized to movements of optical symbol 120 on display 112. In one aspect system 1200 may be used to render a media item stored in tablet computer 144 through remote control 106. In another aspect, system 1200 may be used to transfer an advertising message from television system 102 to tablet computer 144. In yet another aspect, system 1200 may be used to transfer at least a part of video program being rendered by television system 102 to tablet computer 144 and/or to smart watch 106. In still another aspect, system 1200 may be used to transfer a recorded video program from television system 102 to smart watch 106 and/or to tablet computer 144. The video program may be pre-selected by the user through a program list and be recorded according a schedule.

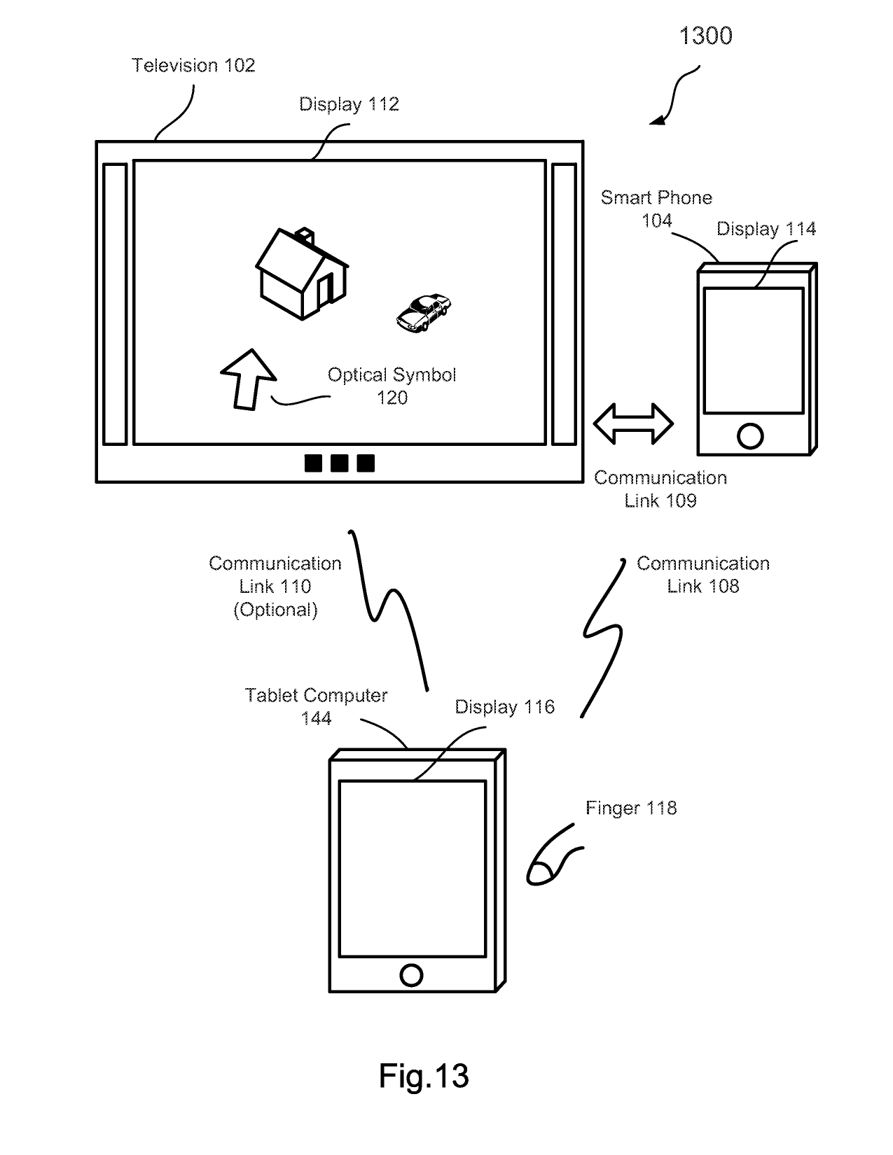

FIG. 13 is a schematic diagram of an exemplary media delivery system 1300 in accordance with a fifth embodiment. System 1300 includes television system 102, smart phone 104 and tablet computer 144. Smart phone 104 is connected to television system 102 through communication link 109. Tablet computer 144 is connected to smart phone 104 through communication link 108. Tablet computer 144 can be connected optionally to television system 102 through communication link 110. Finger 118 touches display 117 of tablet computer 144 and a control signal is generated. In one implementation, generated control signal is transmitted from tablet computer 144 to television system 102 through communication link 110. In another implementation, generated control signal is transmitted from tablet computer 144 to television system 102 via smart phone 104 through communication links 108 and 109. Movements of finger 118 on display 117 are synchronized to movements of optical symbol 120 on display 112. In one aspect, system 1300 may be used to render a media item stored in smart phone 104 through remote control 144. In another aspect, system 1300 may be used to transfer an advertising message from television system 102 to smart phone 104. In yet another aspect, system 1300 may be used to transfer at least a part of video program being rendered by television system 102 to smart phone and/or to tablet computer 144. In still another aspect, system 1300 may be used to transfer a recorded video program from television system 102 to smart phone 104 and/or to tablet computer 144. The video program may be pre-selected by the user through a program list and be recorded according a schedule.

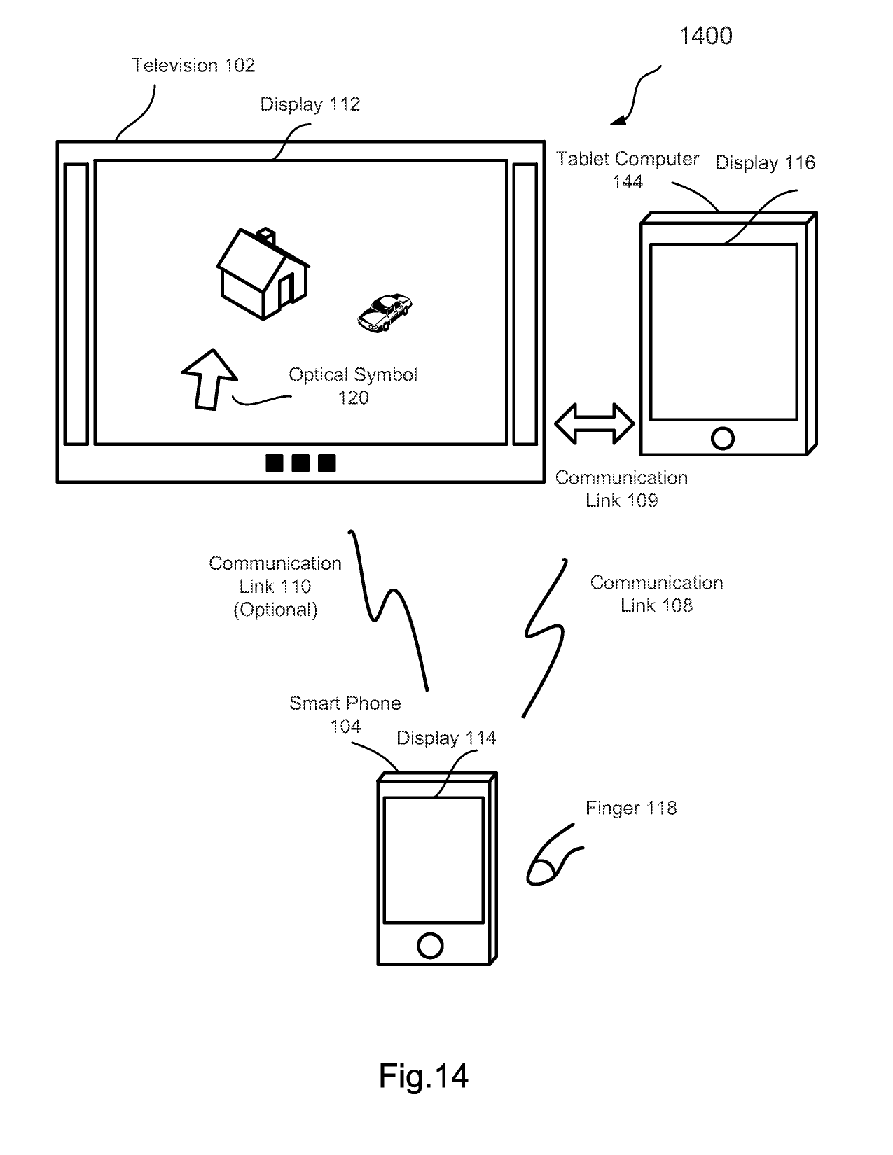

FIG. 14 is a schematic diagram of an exemplary media delivery system 1400 in accordance with a sixth embodiment. System 1400 includes television system 102, smart phone 104 and tablet computer 144. Tablet computer 144 is connected to television system 102 through communication link 109. Smart phone 104 is connected to tablet computer 144 through communication link 108. Smart phone 104 can be connected optionally to television system 102 through communication link 110. Finger 118 touches display 116 of smart phone 104 and a control signal is generated. In one implementation, generated control signal is transmitted from smart phone 104 to television system 102 through communication link 110. In another implementation, generated control signal is transmitted from smart phone 104 to television system 102 via tablet computer 144 through communication links 108 and 109. Movements of finger 118 on display 116 are synchronized to movements of optical symbol 120 on display 112. In one aspect, system 1400 may be used to render a media item stored in tablet computer 144 through remote control 104. In another aspect, system 1400 may be used to transfer an advertising message from television system 102 to tablet computer 144. In yet another aspect, system 1400 may be used to transfer at least a part of video program being rendered by television system 102 to tablet computer 144 and/or to smart phone 104. In still another aspect, system 1400 may be used to transfer a recorded video program from television system 102 to smart phone 104 and/or to tablet computer 144. The video program may be pre-selected by the user through a program list and be recorded according a schedule.

Present inventive concepts are illustrated by the first to sixth embodiments. The present inventive concept can be readily extended to other personal devices. For example, a laptop computer can be used to replace the tablet computer in anyone of the embodiments. A desktop computer can be used to replace tablet computer in anyone of the embodiments. A game console can be used to replace the tablet computer in anyone of the embodiments. A handheld media player can be used to replace the smart phone in anyone of the embodiments. A HiFi audio system can be used to replace the television system in anyone of the embodiments. An automobile media delivery system can be used to replace the television system in anyone of the embodiments. An airplane media delivery system can be used to replace the television system in anyone of the embodiments. A touchpad can be used to replace the touch-sensitive display as the input device of the remote control device in anyone of the embodiments. Keys and buttons can be used to replace the touch-sensitive display as the input device of the remote control device in anyone of the embodiments. Further, a dedicated remote control device may be used to replace anyone of devices as remote control device in anyone of the embodiments. All such variations fall into scope of the present inventive concept as obvious for one with ordinary skill in the art.

1. A media delivery system comprising:
a. a television system;
b. a smart watch connected to said television system through a first ad hoc communication link; and
c. a smart phone connected to said smart watch through a second ad hoc communication link,
wherein said smart phone is used as a remote control device for said television system via said smart watch.

2. The system as recited in claim 1, wherein said smart phone receives a user input and transmits a control signal to said television system via said smart watch.

3. The system as recited in claim 1, wherein said smart phone further comprising a touch-sensitive display and said television system comprising a display.

4. The system as recited in claim 3, wherein movements of a user's finger on the touch-sensitive display are synchronized to movements of an optical symbol displayed on the display of the television system, wherein signals generated by the movements of the finger are transmitted to said television system via said smart watch.

5. The system as recited in claim 1, wherein a media item stored in a data storage unit of said smart watch is transferred from said smart watch to said television system, remotely controlled by said smart phone.

6. The system as recited in claim 1, wherein an advertising message is transferred from said television system to said smart watch, remotely controlled by said smart phone.

7. The system as recited in claim 1, wherein at least a part of video program is transferred from said television system to said smart watch, remotely controlled by said smart phone.

8. The system as recited in claim 1, wherein a data file is transferred from said television system to said smart phone via said smart watch through said first and second ad hoc communication links.

9. The system as recited in claim 8, wherein received data file is stored in a data storage unit of said smart phone and an icon representing the data file is displayed on a display of said smart phone.

10. The system as recited in claim 8, wherein said first and said second ad hoc communication links are wireless ad hoc communication links.

11. The system as recited in claim 10, wherein said wireless communication links further comprising Bluetooth type of links.

12. The system as recited in claim 10, wherein said wireless communication links further comprising Near Field Communication links.

13. The system as recited in claim 1, wherein said first ad hoc communication link further comprising wired communication link including a docking system.

14. A media delivery system comprising:
a. a television system;
b. a smart watch; and
c. a smart phone,
wherein said television system, said smart watch and said smart phone form an ad hoc communication network,
wherein said smart phone is used as a remote control pertaining to controlling data transfer among said television system, said smart watch and said smart phone.

15. The system as recited in claim 14, wherein said smart phone further comprising a touch-sensitive display and said television system comprising a display.

16. The system as recited in claim 15, wherein movements of a user's finger on the touch-sensitive display are synchronized to movements of an optical symbol displayed on the display of the television system, wherein signals generated by the movements of finger are transmitted to said television system via said smart watch.

17. The system as recited in claim 14, wherein said smart watch is connected to said television system through a docking system.

18. The system as recited in claim 14, wherein said smart watch is connected to said television system through a Near Field Communication link.

19. An advertisement delivery system comprising:
a. a television system;
b. a smart watch connected to the television system through an ad hoc communication link; and
c. a smart phone pertaining to remotely controlling of transferring an advertising message included in a video program being rendered by said television system to said smart watch through said ad hoc communication link.

20. The system as recited in claim 19, wherein said advertising message is transferred from said smart watch to said smart phone, wherein an icon representing said advertising message is displayed on a display of said smart phone.
